(19) United States
(12) Patent Application Publication
(10) Pub. No.: US 2023/0238994 A1
(43) Pub. Date: Jul. 27, 2023

(54) RADIO FREQUENCY FRONT-END CHIP

(71) Applicant: AIXlink Ltd., Chengdu City (CN)

(72) Inventors: Chih-Cheng LIN, Hsinchu City (TW); Kuan-Hsiu CHIEN, Hsinchu City (TW)

(73) Assignee: AIXlink Ltd., Chengdu City (CN)

(21) Appl. No.: 18/082,584

(22) Filed: Dec. 16, 2022

Related U.S. Application Data
(60) Provisional application No. 63/301,979, filed on Jan. 21, 2022.

(51) Int. Cl. H04B 1/18; H04B 1/00

(52) U.S. Cl. CPC H04B 1/18; H04B 1/0078

(57) ABSTRACT

Disclosed is a radio frequency (RF) front-end chip provided with a first antenna port and including a RF analog front-end module, a filtering module, and a switching module. The RF analog front-end module includes a first transceiver unit transmitting and receiving a signal of a first frequency band, and a second transceiver unit and a third transceiver unit transmitting and receiving a signal of a second frequency band. The filtering module transmits the received signal to the first transceiver unit or the second transceiver unit and the third transceiver unit based on the frequency band of the received signal. The switching module switches the first antenna port to the first transceiver unit, the second transceiver unit, the third transceiver unit or the filtering module, so that the first transceiver unit, the second transceiver unit or the third transceiver unit receives or transmits a signal through the first antenna port.

### CROSS REFERENCE TO RELATED APPLICATION

This application claims the priority benefit of U.S. Provisional Patent Application Ser. No. 63/301,979, filed on Jan. 21, 2022, the full disclosure of which is incorporated herein by reference.

### BACKGROUND

### Technical Field

The present disclosure relates to the field of communication technologies, and, to a radio frequency (RF) front-end chip.

### Related Art

With the continuous development of mobile communication networks, the communication device can support communication with other terminals through RF signals of different frequency bands to meet different communication requirements.

The existing communication device may comprise a baseband chip, a transceiver, and a RF circuit, wherein the RF circuit is a core component of the communication device, and mainly comprises a RF front end and an antenna. Because the communication device uses the signals of different frequency bands to communicate with different terminals, the existing communication device is usually realized by adding external components, such as a duplexer and a RF chip, connected to the existing RF chip in the RF front-end. However, since the RF chip and its connected external components are discrete devices, the RF front end has the problem that external components occupy the pins of the RF chip and occupy a large layout area, making it impossible to achieve miniaturization.

Therefore, how to provide a solution for solving the above-mentioned technical problem is the problem that those skilled in the art need to solve at present.

### SUMMARY

The embodiments of the present disclosure provide a RF front-end chip, which can solve the problem that the existing communication device using signals of different frequency bands to communication with other terminals cannot be miniaturized because the RF chip in the RF front-end and its connected external components are discrete devices, resulting in the external components occupying the pins of the RF chip and occupying a large layout area.

In order to solve above-mentioned technical problem, the present disclosure is implemented as follows.

The present disclosure provides a RF front-end chip, which is provided with a first antenna port, and includes a RF analog front-end module, a filtering module, and a switching module. The RF analog front-end module includes a first transceiver unit, a second transceiver unit, and a third transceiver unit. The first transceiver unit transmits and receives a signal of a first frequency band, and the second transceiver unit and the third transceiver unit transmit and receive a signal of a second frequency band. The first transceiver unit includes a first receiving end and a first sending end, the second transceiver unit includes a second receiving end and a second sending end, and the third transceiver unit includes a third receiving end and a third sending end. The filtering module is connected to the first receiving end, the second receiving end and the third receiving end, and is configured to transmit the signal of the first frequency band to the first receiving end when receiving the signal of the first frequency band; and transmit the signal of the second frequency band to the second receiving end and the third receiving end when receiving the signal of the second frequency band. The switching module is configured to switch the first antenna port to the first sending end, the second sending end, the third sending end or the filtering module, so that the first transceiver unit, the second transceiver unit or the third transceiver unit receives or transmits a signal through the first antenna port.

In the RF front-end chip of the embodiment of the present disclosure, by the configurations of the switching module and the filter module, the signal of the second frequency band that the RF front-end chip receives is transmitted to the second transceiver unit and the third transceiver unit, and the signal of the first frequency band that the RF front-end chip receives is transmitted to the first transceiver unit to realize the reception of signals of different frequency bands; by the configuration of the switching module, the signals of different frequency bands output by the first transceiver unit, the second transceiver unit and the third transceiver unit can be sent through the first antenna port; thus, the RF front-end chip can realize the transmission and reception of signals of different frequency bands. In addition, by integrating the RF analog front-end module, the filter module and switching module into the RF front-end chip, the miniaturization of the RF front-end is realized.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a schematic diagram of a first embodiment of a radio frequency front-end chip of the present disclosure connected to an antenna;

FIG. 2 is a schematic diagram of a second embodiment of a radio frequency front-end chip of the present disclosure connected to an antenna;

FIG. 3 is a schematic diagram of a third embodiment of a radio frequency front-end chip of the present disclosure connected to an antenna;

FIG. 4 is a schematic diagram of a fourth embodiment of a radio frequency front-end chip of the present disclosure connected to an antenna;

FIG. 5 is a schematic diagram of a fifth embodiment of a radio frequency front-end chip of the present disclosure connected to an antenna;

FIG. 6 is a schematic diagram of a sixth embodiment of a radio frequency front-end chip of the present disclosure connected to an antenna;

FIG. 7 is a schematic diagram of a seventh embodiment of a radio frequency front-end chip of the present disclosure connected to an antenna;

FIG. 8 is a schematic diagram of an eighth embodiment of a radio frequency front-end chip of the present disclosure connected to an antenna;

FIG. 9 is a schematic diagram of a nineth embodiment of a radio frequency front-end chip of the present disclosure connected to an antenna; and

FIG. 10 is a schematic diagram of a communication device according to an embodiment of the present disclosure.

### DETAILED DESCRIPTION OF THE EMBODIMENTS

The following embodiments describe the features and advantages of the present disclosure in detail, but do not limit the scope of the present disclosure in any point of view. According to the description, claims, and drawings, a person ordinarily skilled in the art can easily understand the technical content of the present disclosure and implement it accordingly.

The embodiments of the present disclosure will be described below in conjunction with the relevant drawings. In the figures, the same reference numbers refer to the same or similar components or method flows.

It must be understood that the words “including”, “comprising” and the like used in this specification are used to indicate the existence of specific technical features, values, method steps, work processes, elements and/or components. However, it does not exclude that more technical features, values, method steps, work processes, elements, components, or any combination of the above can be added.

It must be understood that when an element is described as being “connected” or “coupled” to another element, it may be directly connected or coupled to another element, and intermediate elements therebetween may be present. In contrast, when an element is described as “directly connected” or “directly coupled” to another element, there is no intervening element therebetween.

In addition, although the terms such as “first”, “second”, etc., are used herein to describe different elements or operations, these terms are only used to distinguish elements or operations described with the same technical terms.

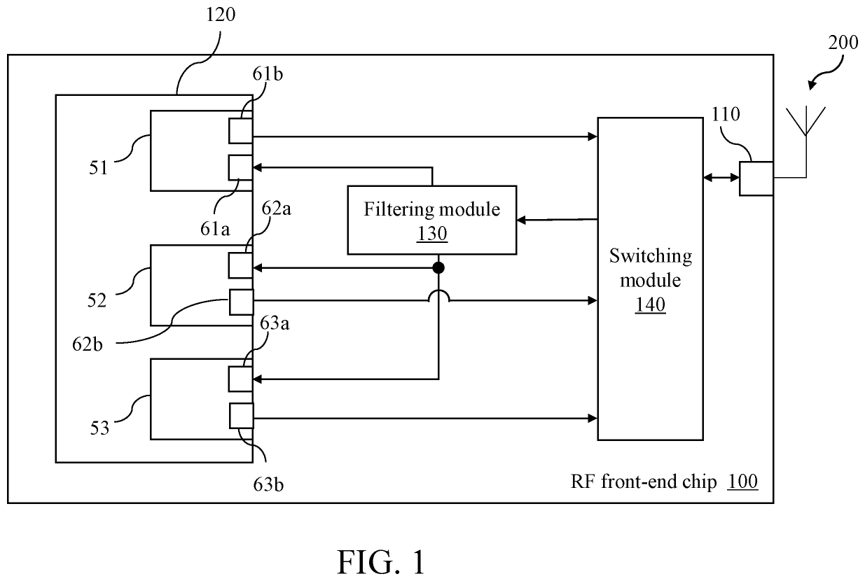

Please refer to FIG. 1, which is a schematic diagram of a first embodiment of a radio frequency front-end chip of the present disclosure connected to an antenna. As shown in FIG. 1, the RF front-end chip 100 is provided with a first antenna port 110, and comprises a RF analog front-end module 120, a filtering module 130 and a switching module 140. The RF analog front-end module 120, the filtering module 130 and the switching module 140 are integrated into the RF front-end chip 100 to realize miniaturization of the RF front-end.

The first antenna port 110 is connected to the antenna 200 that can transmit and receive RF signals in the 2.4G frequency band and RF signals in the 5G frequency band (that is, the WIFI signal in the 5G frequency band, the Wi-Fi signal in the 2.4G frequency band, and the Bluetooth signal in the 2.4G frequency band), but this embodiment is not intended to limit the present disclosure.

The RF analog front-end module 120 comprises a first transceiver unit 51, a second transceiver unit 52 and a third transceiver unit 53, wherein the first transceiver unit 51 transmits and receives a signal of a first frequency band, the second transceiver unit 52 and the third transceiver unit 53 transmit and receive a signal of a second frequency band, the first transceiver unit 51 comprises a first receiving end 61a and a first sending end 61b, the second transceiver unit 52 comprises a second receiving end 62a and a second sending end 62b, and the third transceiver unit 53 comprises a third receiving end 63a and a third sending end 63b. In this embodiment, the first transceiver unit 51 transmits and receives WIFI signals in the 5G frequency band, and the second transceiver unit 52 and the third transceiver unit 53 transmit and receive RF signals in the 2.4G frequency band, wherein the second transceiver unit 52 transmits and receives WIFI signals in the 2.4G frequency band, and the third transceiver unit 53 transmits and receives Bluetooth signals in the 2.4G frequency band.

The filtering module 130 is connected to the first receiving end 61a, the second receiving end 62a and the third receiving end 63a, and is configured to transmit the signal of the first frequency band to the first receiving end 61a when receiving the signal of the first frequency band, and transmit the signal of the second frequency band to the second receiving end 62a and the third receiving end 63a when receiving the signal of the second frequency band. Therefore, by the configuration of the filtering module 130, the RF front-end chip 100 can transmit the signal received through the antenna 200 to the first receiving end 61a or the second receiving end 62a and the third receiving end 63a based on the frequency band of the signal. It should be noted that, since the RF front-end chip 100 does not need to determine that the signal of the second frequency band (i.e., the signal in the 2.4G frequency band) received through the antenna 200 is a WIFI signal or a Bluetooth signal, the RF front-end chip 100 only needs to transmit the received signal of the second frequency band to the second receiving end 62a and the third receiving end 63a through the filtering module 130.

The switching module 140 is configured to switch the first antenna port 110 to the first sending end 61b, the second sending end 62b, the third sending end 63b or the filtering module 130, so that the first transceiver unit 51, the second transceiver unit 52 or the third transceiver unit 53 receives or transmits a signal through the first antenna port 110. Specifically, when the switching module 140 switches the first antenna port 110 to connect to the first sending end 61b, the first transceiver unit 51 can transmit the WIFI signal in the 5G frequency band through the first antenna port 110. When the switching module 140 switches the first antenna port 110 to connect to the second sending end 62b, the second transceiver unit 52 can transmit the WIFI signal in the 2.4G frequency band through the first antenna port 110. When the switching module 140 switches the first antenna port 110 to connect to the third sending end 63b, the third transceiver unit 53 can transmit the Bluetooth signal in the 2.4G frequency band through the first antenna port 110. When the switching module 140 switches the first antenna port 110 to connect to the filter module 130, the signal in the 5G frequency band can be transmitted to the first transceiver unit 51 through the filtering module 130, and the signal in the 2.4G frequency band can be transmitted to the second transceiver unit 52 and the third transceiver unit 53 through the filtering module 130. The switching module 140 may be, but not limited to, a single-pole four-throw (SP4T) switch. However, this embodiment is not intended to limit the present disclosure.

The RF front-end chip 100 of the above-mentioned embodiment is only provided with the first antenna port 110, so only a single antenna 200 can be connected to the RF front-end chip 100, and the RF front-end chip 100 can only receive or transmit a RF signal of a single frequency band at the same time. In order to expand the application range of the RF front-end chip 100, the RF front-end chip 100 can be further provided with a second antenna port 150 connected to another antenna 300, so that the RF front-end chip 100 can simultaneously transmit and receive RF signals in the 5G frequency band and RF signals in the 2.4G frequency band, wherein the antenna 300 may be a single-frequency antenna for transmitting and receiving signals in the 2.4G frequency band. The details are as follows. It should be noted that the RF front-end chip 100 in the following embodiments is connected to the antenna 200 and the antenna 300, but the RF front-end chip 100 in the following embodiments can also be applied to an application scenario where only the antenna 200 or the antenna 300 is connected to the RF front-end chip 100, which can be adjusted according to the needs of users. That is to say, the RF front-end chip 100 of the present disclosure can be applied to the application scenario where a single antenna is connected to the RF front-end chip 100 or two antennas are connected to the RF front-end chip 100.

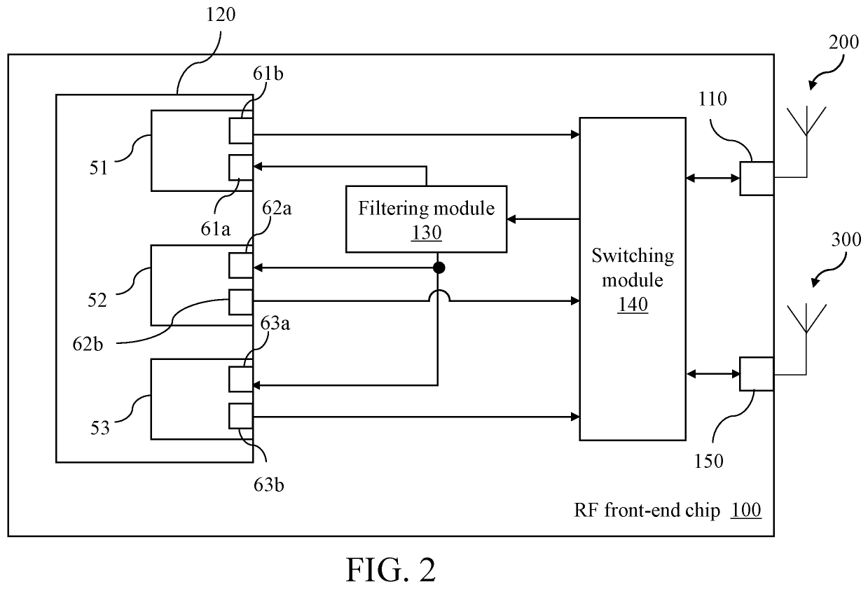

Please refer to FIG. 2, which is a schematic diagram of a second embodiment of a radio frequency front-end chip of the present disclosure connected to an antenna. As shown in FIG. 2, in addition to being provided with the first antenna port 110, the RF front-end chip 100 may be further provided with a second antenna port 150 connected to another antenna 300 for transmitting and receiving signals in the 2.4G frequency band. The switching module 140 may be further configured to selectively transmit the signals transmitted by the second sending end 62b and the third sending end 63b to the second antenna port 150, and transmit the signal of the second frequency band from the second antenna port 150 to the filtering module 130. Specifically, when the switching module 140 switches the second antenna port 150 to connect to the second sending end 62b, the second transceiver unit 52 can transmit the WIFI signal in the 2.4G frequency band through the second antenna port 150. When the switching module 140 switches the second antenna port 150 to connect to the third sending end 63b, the third transceiver unit 53 can transmit the Bluetooth signal in the 2.4G frequency band through the second antenna port 150. When the switching module 140 switches the second antenna port 150 to connect to the filtering module 130, the second transceiver unit 52 and the third transceiver unit 53 can receive Bluetooth signals in the 2.4G frequency band through the second antenna port 150 and the filter module 130. However, this embodiment is not intended to limit the present disclosure.

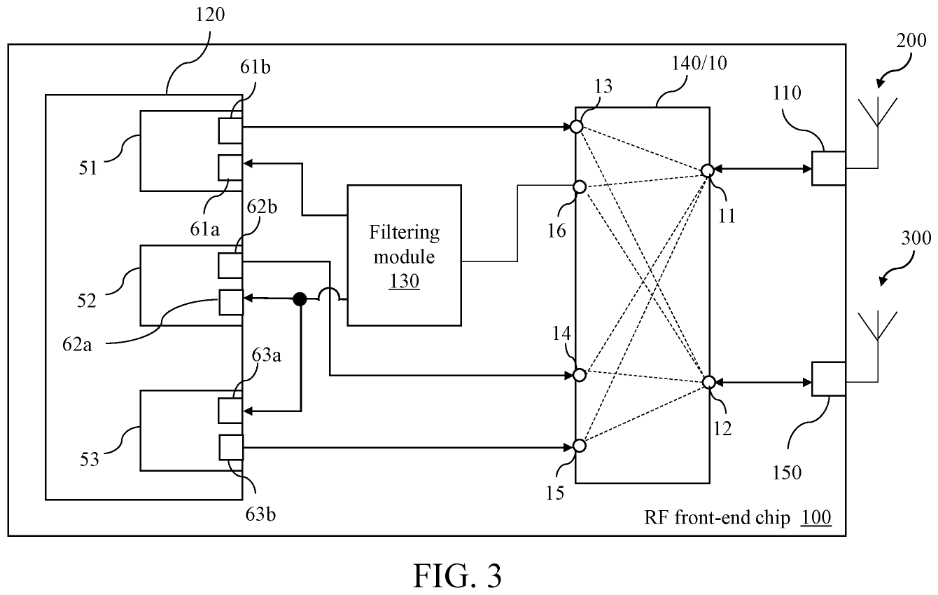

In an embodiment, the switching module 140 may be a double-pole four-throw (DP4T) switch 10, and the DP4T switch 10 comprises a first common end 11, a second common end 12, a first connecting end 13, a second connecting end 14, a third connecting end 15 and a fourth connecting end 16, wherein the first common end 11 is connected to the first antenna port 110, the second common end 12 is connected to the second antenna port 150, the first connecting end 13 is connected to the first sending end 61b, the second connecting end 14 is connected to the second sending end 62b, the third connecting end 15 is connected to the third sending end 63b, and the fourth connecting end 16 is connected to the filtering module 130, as shown in FIG. 3, which is a schematic diagram of a third embodiment of a radio frequency front-end chip of the present disclosure connected to an antenna. Therefore, the switching module 140 can switch the first antenna port 110 to connect to the first sending end 61b, the second sending end 62b, the third sending end 63b or the filtering module 130, and the switching module 140 can switch the second antenna port 150 to connect to the first sending end 61b, the second sending end 62b, the third sending end 63b or the filtering module 130, but this embodiment is not intended to limit the present disclosure.

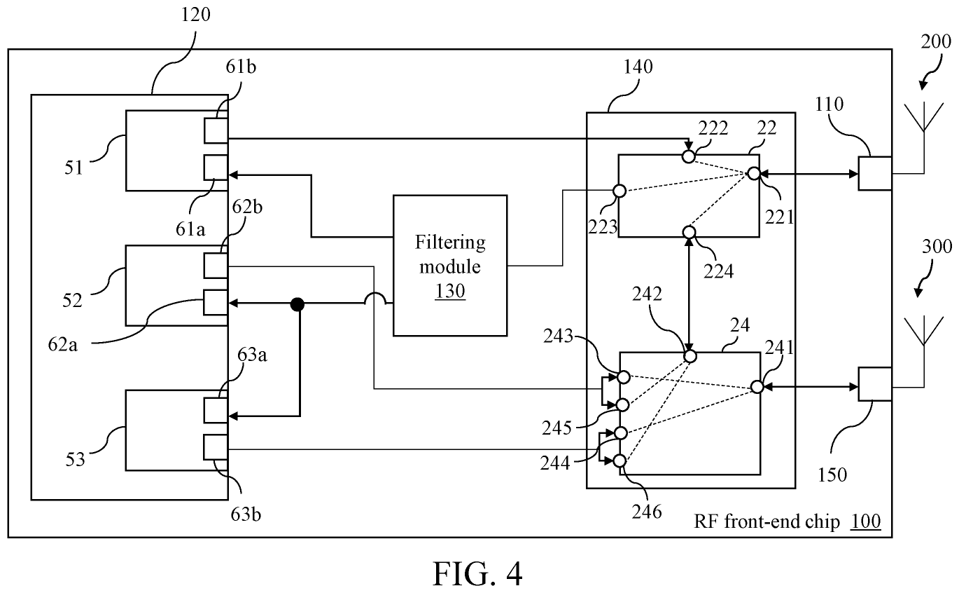

In another embodiment, the switching module 140 may comprise a single-pole three-throw (SP3T) switch 22 and a double-pole double-throw (DPDT) switch 24, the SP3T switch 22 comprises a third common end 221, a fifth connecting end 222, and a sixth connecting end 223 and a seventh connecting end 224, and the DPDT switch 24 comprises a fourth common end 241, a fifth common end 242, an eighth connecting end 243, a ninth connecting end 244, a tenth connecting end 245 and an eleventh connecting end 246, wherein the third common end 221 is connected to the first antenna port 110, the fifth connecting end 222 is connected to the first sending end 61b, the sixth connecting end 223 is connected to the filtering module 130, the seventh connecting end 224 is connected to the fifth common end 242, the fourth common end 241 is connected to the second antenna port 150, the eighth connecting end 243 and the tenth connecting end 245 are connected to the second sending end 62b, the ninth connecting end 244 and the eleventh connecting end 246 are connected to the third sending end 62b, the fourth common end 241 is connected to the eighth connecting end 243 or the ninth connecting end 244, and the fifth common end 242 is connected to the tenth connecting end 245 or the eleventh connecting end 246, as shown in FIG. 4, which is a schematic diagram of a fourth embodiment of a radio frequency front-end chip of the present disclosure connected to an antenna.

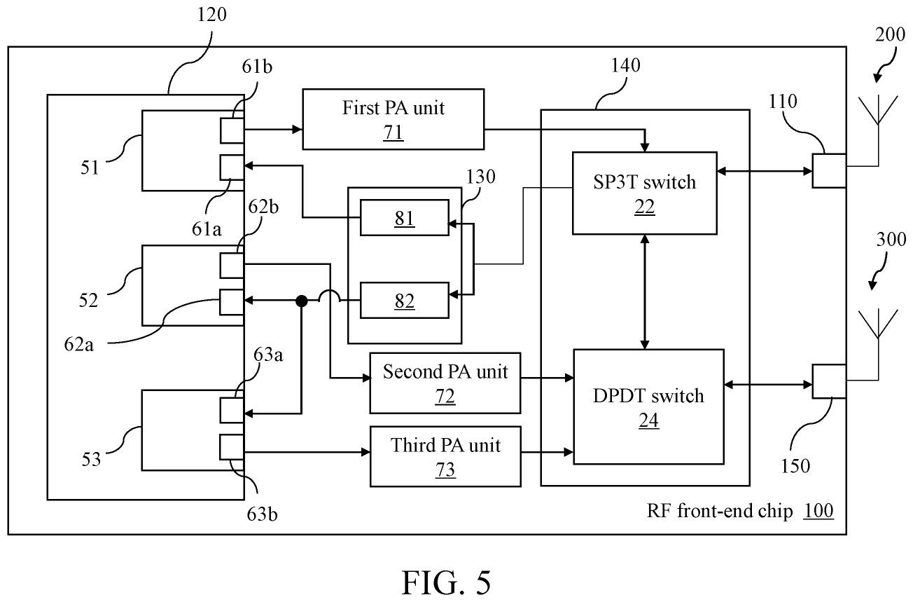

Please refer to FIG. 5, which is a schematic diagram of a fifth embodiment of a radio frequency front-end chip of the present disclosure connected to an antenna. As shown in FIG. 5, in addition to being provided with the first antenna port 110 and the second antenna port 150 and comprising the RF analog front-end module 120, the filtering module 130 and the switching module 140, the RF front-end chip 100 may further comprise a first power amplifier (PA) unit 71, a second PA unit 72 and a third PA unit 73, wherein the first PA unit 71 is disposed between the first sending end 61b and the switching module 140, the second PA unit 72 is disposed between the second sending end 62b and the switching module 140, and the third PA unit 73 is disposed between the third sending end 63b and the switching module 140. Specifically, the first PA unit 71 is configured to amplify the WIFI signal in the 5G frequency band transmitted by the first sending end 61b, the second PA unit 72 is configured to amplify the WIFI signal in the 2.4G frequency band transmitted by the second sending end 62b, and the third PA unit 73 is configured to amplify the Bluetooth signal in the 2.4G frequency band transmitted by the third sending end 63b.

In one embodiment, the filtering module 130 may comprise a first filtering unit 81 and a second filtering unit 82, wherein an input end of the first filtering unit 81 is connected to the switching module 140, an output end of the first filtering unit 81 is connected to the first receiving end 61a, the first filtering unit 81 is configured to filter out the signal in the 2.4G frequency band, an input end of the second filtering unit 82 is connected to the switching module 140, an output end of the second filtering unit 82 is connected to the second receiving end 62a and the third receiving end 63a, and the second filtering unit 82 is configured to filter out the signal in the 5G frequency band. Therefore, only the signal in the 5G frequency band can be transmitted to the first transceiver unit 51, and only the signal in the 2.4G frequency band can be transmitted to the second transceiver unit 52 and the third transceiver unit 53.

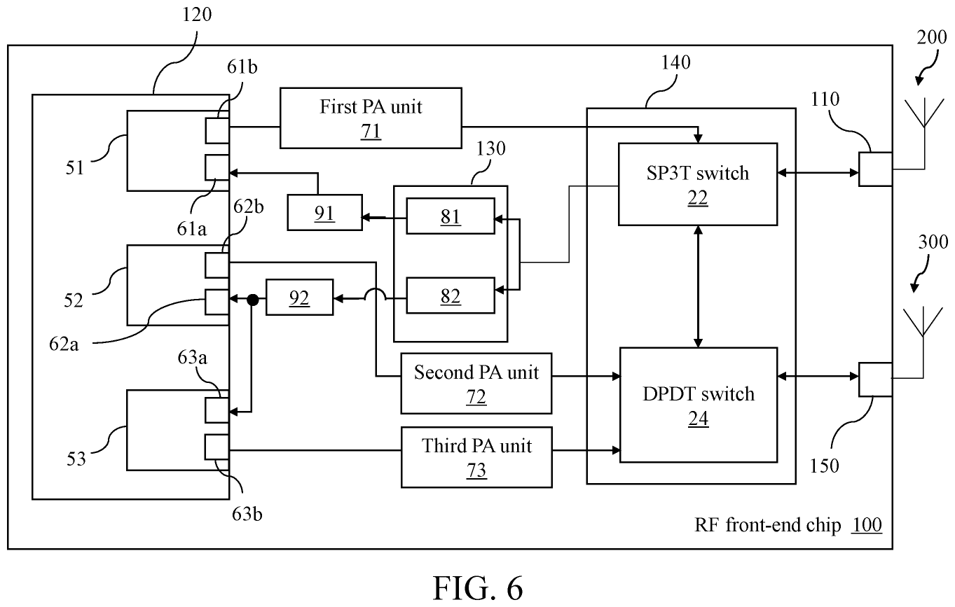

Please refer to FIG. 6, which is a schematic diagram of a sixth embodiment of a radio frequency front-end chip of the present disclosure connected to an antenna. As shown in FIG. 6, in addition to being provided with the first antenna port 110 and the second antenna port 150 and comprising the RF analog front-end module 120, the filtering module 130, the switching module 140, the first PA unit 71, the second PA unit 72 and the third PA unit 73, the RF front-end chip 100 may further comprise a first low-noise amplifier (LNA) unit 91 and a second LNA unit 92, wherein the first LNA unit 91 is disposed between the first receiving end 61a and the filtering module 130, the second LNA unit 92 is disposed between the second receiving end 62a and the filtering module 130 and between the third receiving end 63a and the filtering module 130. Specifically, the first LNA unit 91 is configured to amplify the WIFI signal in the 5G frequency band received from the antenna 200 and transmit it to the first receiving end 61a, and the second LNA unit 92 is configured to amplify the WIFI signal in the 2.4G frequency band received from the antenna 200 or the antenna 300, and transmit it to the second receiving end 62a and the third receiving end 63a.

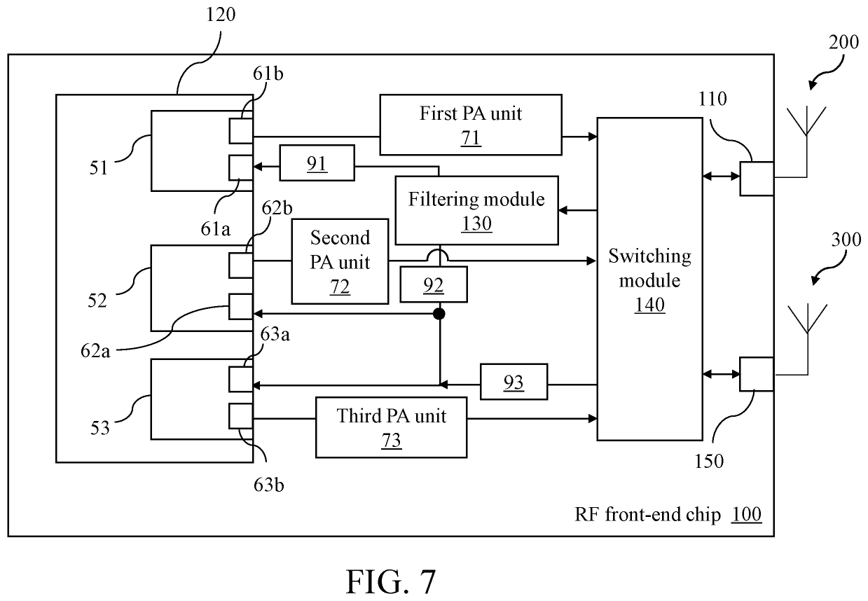

Please refer to FIG. 7, which is a schematic diagram of a seventh embodiment of a radio frequency front-end chip of the present disclosure connected to an antenna. As shown in FIG. 7, the antenna 300 in FIG. 7 only transmits and receives Bluetooth signals in the 2.4G frequency band, so that the switching module 140 in FIG. 7 can also transmit the Bluetooth signals in the 2.4G frequency band received by the antenna 300 to the third receiving end 63a. The RF front-end chip 100 in FIG. 7 may further comprise a third LNA unit 93, wherein the third LNA unit 93 is disposed between the third receiving end 63a and the switching module 140. Specifically, the third LNA unit 93 is configured to amplify the signal in the 2.4G frequency band received from the antenna 300 and transmit it to the third receiving end 63a.

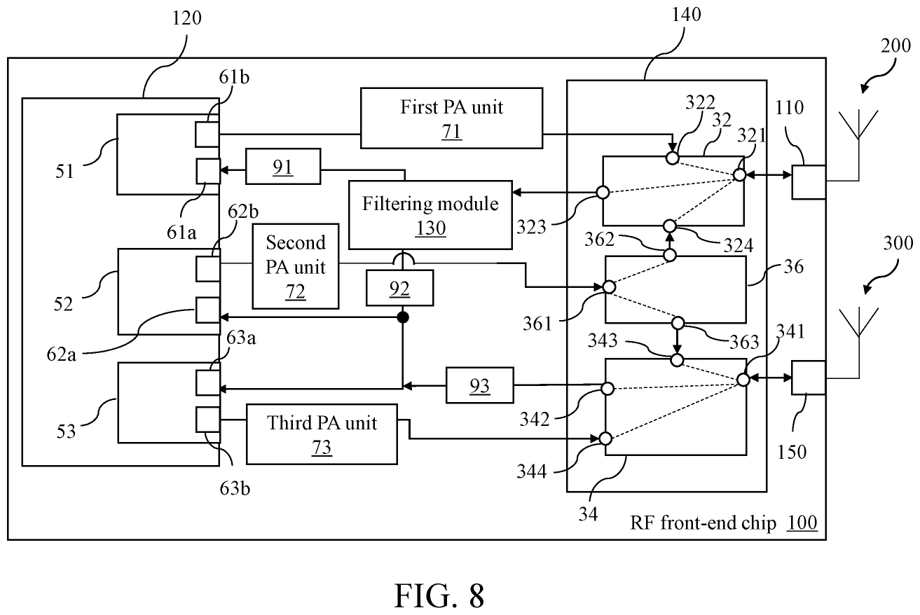

In one embodiment, the switching module 140 may comprise a first SP3T switch 32, a second SP3T switch 34 and a single-pole double-throw (SPDT) switch 36, the first SP3T switch 32 comprise s a sixth common end 321, a twelfth connecting end 322, a thirteenth connecting end 323 and a fourteenth connecting end 324, the second SP3T switch 34 comprises the seventh common end 341, a fifteenth connecting end 342, a sixteenth connecting end 343 and a seventeenth connecting end 344, and the SPDT switch 36 comprises an eighth common end 361, an eighteenth connecting end 362 and a nineteenth connecting end 363, wherein the sixth common end 321 is connected to the first antenna port 110, the twelfth connecting end 322 is connected to the first sending end 61b, the thirteenth connecting end 323 is connected to the filtering module 130, the fourteenth connecting end 324 is connected to the eighteenth connecting end 362, the seventh common end 341 is connected to the second antenna port 150, the fifteenth connecting end 342 is connected to the third receiving end 63a, the sixteenth connecting end 343 is connected to the nineteenth connecting end 363, the seventeenth connecting end 344 is connected to the third sending end 63b, and the eighth common end 361 is connected to the second sending end 62b, as shown in FIG. 8, which is a schematic diagram of a eighth embodiment of a radio frequency front-end chip of the present disclosure connected to an antenna, but this embodiment is not intended to limit the present disclosure.

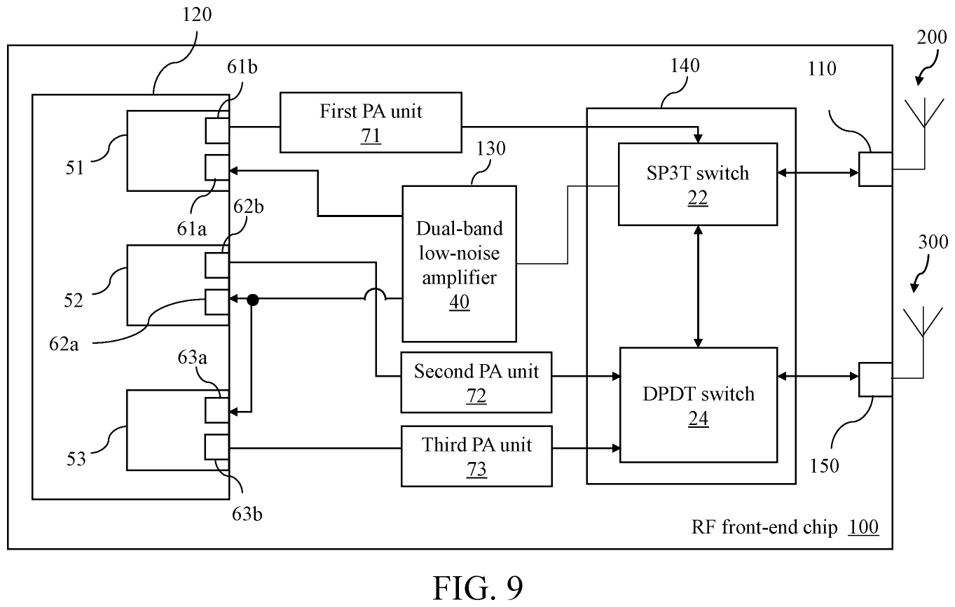

Please refer to FIG. 9, which is a schematic diagram of a nineth embodiment of a radio frequency front-end chip of the present disclosure connected to an antenna. As shown in FIG. 9, the filtering module 130, the first LNA unit 91 and the second LNA unit 92 in FIG. 6 are integrated into a dual-band low-noise amplifier 40. That is, the filtering module 130 in FIG. 9 may be a dual-band low-noise amplifier 40. The dual-band low-noise amplifier 40 has the functions of a LNA and a dual-band filter. The configuration of the dual-band low-noise amplifier 40 is beneficial to realize the miniaturization of the RF front-end chip 100.

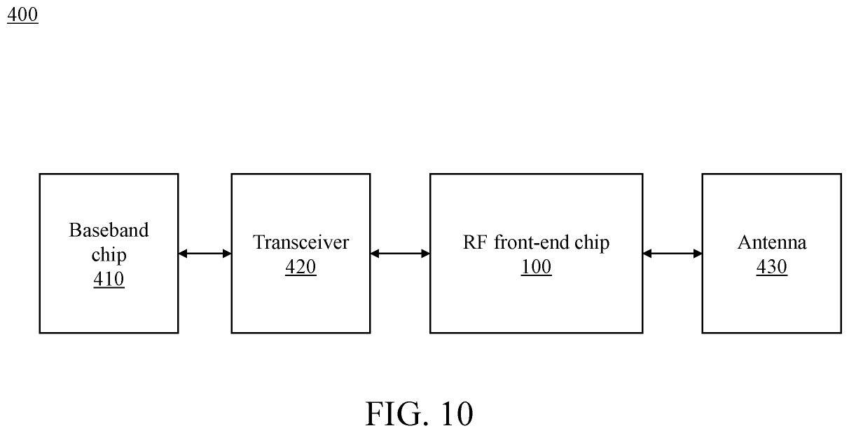

Please refer to FIG. 10, which is a schematic diagram of a communication device according to an embodiment of the present disclosure. As shown in FIG. 10, the communication device 400 comprises a baseband chip 410, a transceiver 420, at least one antenna 430 and the RF front-end chip 100, the baseband chip 410 is connected to the transceiver 420, the transceiver 420 is connected to the RF front-end chip 100, and the RF front-end chip 100 is connected to the at least one antenna 430, wherein the baseband chip 410 is configured to process a baseband signal received from the transceiver 420, and generates a baseband signal that needs to be sent by the transceiver 420; the transceiver 420 is configured to convert RF signals of different frequency bands from the RF front-end chip 100 into corresponding baseband signals, and convert the baseband signals from the baseband chip 410 into RF signals of corresponding frequency bands; and the RF front-end chip 100 is configured to transmit and receive RF signals of different frequency bands through the at least one antenna 430. In this embodiment, the communication device 400 may be a wireless terminal such as a mobile phone, a tablet computer, and a computer with a wireless transceiver function, and may be widely used in wireless communication for smart industry, smart home, smart medical treatment, Internet of Things (IOT) and other applications; the RF front-end chip 100 can transmit and receive Bluetooth signals in the 2.4G frequency band, WIFI signals in the 2.4G frequency band, and WIFI signals in the 5G frequency band; and the antenna 430 can be a dual-frequency antenna, but this embodiment is not used to limit the present disclosure, and can be adjusted according to actual needs.

Please refer to the following table 1, which is a comparison table showing the insertion loss in the 2.4G frequency band and the 5G frequency band of the RF front-end chip 100 of FIG. 6 and the insertion loss in the 2.4G frequency band and the 5G frequency band of the existing RF front end where the RF chip and its connected external components are discrete devices. As shown in Table 1, compared with the existing RF front end in which the RF chip and its connected external components are discrete devices, the insertion loss of the RF front-end chip 100 in FIG. 6 is smaller in the 2.4G frequency band and 5G frequency band, which is conducive to improving output power and work efficiency.

TABLE 1
The existing RF front end where the RF chip and its
connected external components are discrete devices

| | | | | | | | |
|---|---|---|---|---|---|---|---|
| TX | 2.4 | GHz | −1.52 dB | RX | 2.4 | GHz | −1.52 dB |
| | 2.45 | GHz | −1.63 dB | | 2.45 | GHz | −1.63 dB |
| | 2.5 | GHz | −1.75 dB | | 2.5 | GHz | −1.75 dB |
| TX | 5 | GHz | −2.48 dB | RX | 5 | GHz | −2.48 dB |
| | 5.5 | GHz | −2.14 dB | | 5.5 | GHz | −2.14 dB |
| | 6 | GHz | −2.62 dB | | 6 | GHz | −2.62 dB |

The RF front-end chip 100 of FIG. 6

| | | | | | | | |
|---|---|---|---|---|---|---|---|
| TX | 2.4 | GHz | −0.39 dB | RX | 2.4 | GHz | −1.44 dB |
| | 2.45 | GHz | −0.4 dB | | 2.45 | GHz | −1.52 dB |
| | 2.5 | GHz | −0.41 dB | | 2.5 | GHz | −1.62 dB |
| TX | 5 | GHz | −0.96 dB | RX | 5 | GHz | −2.21 dB |
| | 5.5 | GHz | −0.97 dB | | 5.5 | GHz | −1.74 dB |
| | 6 | GHz | −0.97 dB | | 6 | GHz | −1.72 dB |

To sum up, in the RF front-end chip and the communication device of the present disclosure, by the configurations of the switching module and the filter module, the signal of the second frequency band that the RF front-end chip receives is transmitted to the second transceiver unit and the third transceiver unit, and the signal of the first frequency band that the RF front-end chip receives is transmitted to the first transceiver unit to realize the reception of signals of different frequency bands; by the configuration of the switching module, the signals of different frequency bands output by the first transceiver unit, the second transceiver unit and the third transceiver unit can be sent through the first antenna port; thus, the RF front-end chip can realize the transmission and reception of signals of different frequency bands. In addition, by integrating the RF analog front-end module, the filter module and switching module into the RF front-end chip, the miniaturization of the RF front-end is realized. Besides, by the configurations of the first antenna port and the second antenna port, it is possible to transmit and receive RF signals of different frequency bands at the same time, and the user can apply the RF front-end chip to the application scenario where a single antenna is connected to the RF front-end chip or two antennas are connected to the RF front-end chip according to requirements. Furthermore, by the configuration of the dual-band low noise amplifier, the RF signal from the antenna can be amplified for processing by the transceiver, and at the same time, the miniaturization of the RF front-end chip can be realized.

While the present disclosure is disclosed in the foregoing embodiments, it should be noted that these descriptions are not intended to limit the present disclosure. On the contrary, the present disclosure covers modifications and equivalent arrangements obvious to those skilled in the art. Therefore, the scope of the claims must be interpreted in the broadest manner to comprise all obvious modifications and equivalent arrangements.

What is claimed is:

1. A radio frequency (RF) front-end chip, provided with a first antenna port and comprising:
a RF analog front-end module comprising a first transceiver unit, a second transceiver unit and a third transceiver unit, wherein the first transceiver unit transmits and receives a signal of a first frequency band, the second transceiver unit and the third transceiver unit transmits and receives a signal of a second frequency band, the first transceiver unit comprises a first receiving end and a first sending end, the second transceiver unit comprises a second receiving end and a second sending end, and the third transceiver unit comprises a third receiving end and a third sending end;
a filtering module connected to the first receiving end, the second receiving end and the third receiving end, and configured to transmit the signal of the first frequency band to the first receiving end when receiving the signal of the first frequency band; and transmit the signal of the second frequency band to the second receiving end and the third receiving end when receiving the signal of the second frequency band; and
a switching module configured to switch the first antenna port to the first sending end, the second sending end, the third sending end or the filtering module, so that the first transceiver unit, the second transceiver unit or the third transceiver unit receives or transmits a signal through the first antenna port.

2. The RF front-end chip according to claim 1, wherein the RF front-end chip is further provided with a second antenna port, and the switching module is further configured to selectively transmit the signal transmitted by the second sending end and the third sending end to the second antenna port or the first antenna port; and transmit the signal of the second frequency band from the second antenna port to the filtering module.

3. The RF front-end chip according to claim 2, wherein the switching module is a double-pole four-throw (DP4T) switch, the DP4T switch comprises a first common end, a second common end, a first connecting end, a second connecting end, a third connecting end and a fourth connecting end, the first common end is connected to the first antenna port, the second common end is connected to the second antenna port, the first connecting end is connected to the first sending end, the second connecting end is connected to the second sending end, the third connecting end is connected to the third sending end, and the fourth connecting end is connected to the filtering module.

4. The RF front-end chip according to claim 2, wherein the switching module comprises a single-pole three-throw (SP3T) switch and a double-pole double-throw (DPDT) switch, the SP3T switch comprises a third common end, a fifth connecting end, a sixth connecting end and a seventh connecting end, the DPDT switch comprises a fourth common end, a fifth common end, an eighth connecting end, a ninth connecting end, a tenth connecting end and an eleventh connecting end, the third common end is connected to the first antenna port, the fifth connecting end is connected to the first sending end, the sixth connecting end is connected to the filtering module, the seventh connecting end is connected to the fifth common end, the fourth common end is connected to the second antenna port, the eighth connecting end and the tenth connecting end are connected to the second sending end, and the ninth connecting end and the eleventh connecting end are connected to the third sending end.

5. The RF front-end chip according to claim 2, further comprising: a first power amplifier (PA) unit, a second PA unit and a third PA unit, wherein the first PA unit is disposed between the first sending end and the switching module, the second PA unit is disposed between the second sending end and the switching module, and the third PA unit is disposed between the third sending end and the switching module.

6. The RF front-end chip according to claim 2, further comprising: a first low-noise amplifier (LNA) unit and a second LNA unit, wherein the first LNA unit is disposed between the first receiving end and the filtering module, the second LNA unit is disposed between the second receiving end and the filtering module, and between the third receiving end and the filtering module.

7. The RF front-end chip according to claim 2, wherein the filtering module is a dual-band low-noise amplifier.

8. The RF front-end chip according to claim 2, wherein the filtering module comprises a first filtering unit and a second filtering unit, an input end of the first filtering unit is connected to the switching module, an output end of the first filtering unit is connected to the first receiving end, the first filtering unit is configured to filter out the signal of the second frequency band, an input end of the second filtering unit is connected to the switching module, an output end of the second filtering unit is connected to the second receiving end and the third receiving end, and the second filtering unit is configured to filter out the signal of the first frequency band.

9. The RF front-end chip according to claim 1, further comprising: a first PA unit, a second PA unit and a third PA unit, wherein the first PA unit is disposed between the first sending end and the switching module, the second PA unit is disposed between the second sending end and the switching module, and the third PA unit is disposed between the third sending end and the switching module.

10. The RF front-end chip according to claim 1, further comprising: a first LNA unit and a second LNA unit, wherein the first LNA unit is disposed between the first receiving end and the filtering module, the second LNA unit is disposed between the second receiving end and the filtering module, and between the third receiving end and the filtering module.

11. The RF front-end chip according to claim 10, further comprising: a third LNA unit, wherein the third LNA unit is disposed between the third receiving end and the switching module, and the switching module is further configured to transmit the signal of the second frequency band from the second antenna port to the third receiving end through the third LNA unit.

12. The RF front-end chip according to claim 11, wherein the switching module comprises a first SP3T switch, a second SP3T switch and a single-pole double-throw (SPDT) switch, the first SP3T switch comprises a sixth common end, a twelfth connecting end, the thirteenth connecting end and the fourteenth connecting end, the second SP3T switch comprises a seventh common end, a fifteenth connecting end, a sixteenth connecting end and a seventeen connecting end, the SPDT switch comprises an eighth common end, an eighteenth connecting end and a nineteenth connecting end, the sixth common end is connected to the first antenna port, the twelfth connecting end is connected to the first sending end, the thirteenth connecting end is connected to the filtering module, the fourteenth connecting end is connected to the eighteenth connecting end, the seventh common end is connected to the second antenna port, the fifteenth connecting end is connected to the third receiving terminal, the sixteenth connecting end is connected to the nineteenth connecting end, the seventeenth connecting end is connected to the third sending end, and the eighth common end is connected to the second sending end.

13. The RF front-end chip according to claim 1, wherein the filtering module is a dual-band low-noise amplifier.

14. The RF front-end chip according to claim 1, wherein the filtering module comprises a first filtering unit and a second filtering unit, an input end of the first filtering unit is connected to the switching module, an output end of the first filtering unit is connected to the first receiving end, the first filtering unit is configured to filter out the signal of the second frequency band, an input end of the second filtering unit is connected to the switching module, an output end of the second filtering unit is connected to the second receiving end and the third receiving end, and the second filtering unit is configured to filter out the signal of the first frequency band.
